(19) United States
(12) Patent Application Publication
(10) Pub. No.: US 2016/0109322 A1
(43) Pub. Date: Apr. 21, 2016

(54) LEAK DETECTION USING ACOUSTIC WAVE TRANSDUCER

(71) Applicant: HGST Netherlands B.V., Amsterdam (NL)

(72) Inventors: Hajime Eguchi, Fujisawa-shi (JP); Seong-Hun Choe, Fujisawa-shi (JP); Hiromi Uiji, Chigasaki-shi (JP)

(21) Appl. No.: 14/518,817

(22) Filed: Oct. 20, 2014

(51) Int. Cl. G01M 3/24

(52) U.S. Cl. CPC G01M 3/24

(57) ABSTRACT

The present disclosure relates to a leak detection apparatus that includes an acoustic wave actuator mounted within a hermetically sealed chamber. The hermetically sealed chamber isolates a fluid medium from an external atmosphere and the acoustic wave actuator propagates an acoustic wave through the fluid medium. The apparatus further includes an acoustic wave transducer mounted within the hermetically sealed chamber and a comparison module. The acoustic wave transducer detects fluid pressure wave data related to the acoustic wave. The comparison module calculates an acoustic velocity based on the fluid pressure wave data and compares the acoustic velocity to a predetermined threshold velocity in order to recognize leaks in the hermetically sealed chamber.

### FIELD

This disclosure relates to hermetically sealed chambers, and more particularly to detecting leaks in hermetically sealed chambers using an acoustic wave transducer.

### BACKGROUND

Hard disk drives are widely used to store digital data or electronic information for enterprise data processing systems, computer workstations, portable computing devices, digital audio players, digital video players, and the like. Generally, hard disk drives store data on one or more magnetic recording media that each have a layer made from magnetic material. Hard disk drives include a read/write head with a writing component that magnetically polarizes areas or bits of the magnetic material with different polarities to encode either binary zeros or ones. Thus, data is recorded as magnetically encoded areas or bits of magnetic polarity. The direction of the magnetization can be referred to as one of a positive state and a negative state. Each bit can store information (generally binary information in the form of either a 1 or a 0) according to the magnetic polarization state of the bit. Typically, bits are arranged along respective radially-adjacent (e.g., concentric) annular tracks of a disk. A single disk can include space for millions of tracks each with millions of bits. A read/write head also includes a reading component that detects the magnetic polarity of each bit or area and generates an electrical signal that approximates the magnetic polarity. The signal is processed to recover the binary data recorded on the magnetic material.

The disk platter of a hard disk drive rotates as a read/write head hovers over respective disks to read data from, and write data to, the disks. Rotation of the disks is driven by a spindle motor that is rotatably coupled to the disks via a central spindle. The position of the read/write heads relative to the disks, and the location on the disks from which data is read or to which data is written, is controlled via actuation of an actuator. The actuator controls the movement of read/write heads

The dynamic performance of a hard disk drive is a mechanical factor for achieving higher data capacity and for more quickly manipulating (i.e., reading and writing) the data. The quantity of data tracks recorded on the disk surface is determined, at least partly, by how well the read/write heads and a desired data track can be positioned relative to each other and made to follow each other in a stable and controlled manner.

There are many factors that can influence the ability of a hard disk drive to perform the function of positioning the read/write heads and following the data track with the heads. One such factor is the composition of the internal atmosphere within a chamber of the hard disk drive. Often hard disk drive chambers are hermetically sealed to isolate the hard disk drive components (e.g., the disk platter, spindle, read/write head assembly, etc.) from an external atmosphere, thus facilitating the read/write head to smoothly and closely, “fly” over the disks to read and/or write data. However, if the composition of the internal atmosphere fluctuates or is not constant, such as due to a leak in the hermetically sealed chamber for example, the dynamic performance of the hard disk drive may be impaired as the read/write heads may not “fly” as smoothly over the disks, which can lead to a lower signal-to-noise ratio.

### SUMMARY

The subject matter of the present application has been developed in response to the present state of the art, and in particular, in response to problems and shortcomings of conventional hermetically sealed chambers that have not yet been fully solved by currently available systems. Many conventional hermetically sealed chambers do not have an associated leak detection system. Alternatively, those few conventional hermetically sealed chambers that do have such leak detection systems fail to accurately and directly detect changes in the composition of the internal atmosphere within the hermetically sealed chamber.

In general, the subject matter of the present application has been developed to provide a leak detection system that determines (e.g., measures and/or calculates) the acoustic velocity of the internal atmosphere within a hermetically sealed chamber to detect and recognize changes in the composition of the internal atmosphere.

The present disclosure relates to a leak detection apparatus that includes an acoustic wave actuator mounted within a hermetically sealed chamber. The hermetically sealed chamber isolates a fluid medium from an external atmosphere and the acoustic wave actuator propagates an acoustic wave through the fluid medium. The apparatus further includes an acoustic wave transducer mounted within the hermetically sealed chamber and a comparison module. The acoustic wave transducer detects fluid pressure wave data related to the acoustic wave. The comparison module calculates an acoustic velocity based on the fluid pressure wave data and compares the acoustic velocity to a predetermined threshold velocity.

In one embodiment, the apparatus may further include a recognition module that recognizes composition changes to the fluid medium caused by a leak in the hermetically sealed chamber when the acoustic velocity meets the predetermined threshold. In one embodiment, the acoustic wave transducer is a microphone. In another embodiment, the acoustic wave transducer is a resonant frequency detector, such as a Helmholtz type cavity, a resonance tube, and a resonance cavity within a wall of the hermetically sealed chamber.

The present disclosure also relates to a system that includes a hard disk drive chamber, at least one disk platter assembly, a read/write head assembly, an acoustic wave actuator, and an acoustic wave transducer. The hard disk drive chamber is hermetically sealed to isolate a hard disk drive atmosphere from an external atmosphere. The at least one disk platter assembly and the read/write head assembly are mounted within the hard disk drive chamber. The acoustic wave actuator, mounted within the hard disk drive chamber, propagates an acoustic wave through the hard disk drive atmosphere. The acoustic wave transducer, mounted within the hard disk drive chamber, detects fluid pressure wave data related to the acoustic wave.

In one embodiment, the system may include a comparison module that calculates an acoustic velocity based on the fluid pressure wave data and compares the acoustic velocity to a predetermined threshold velocity. In a further embodiment, the system also includes a recognition module that recognizes composition changes to the hard disk drive atmosphere caused by a leak in the hard disk drive chamber when the acoustic velocity meets the predetermined threshold. In one implementation, the acoustic wave actuator is a standalone component that is independent from conventional hard disk drive components. In another implementation, the acoustic wave actuator is an existing hard disk drive component capable of creating the acoustic wave that propagates through the hard disk drive atmosphere. The acoustic wave transducer may be a microphone or the acoustic wave transducer may be a resonant frequency detector, such as a Helmholtz type cavity, a resonance tube, and a resonance cavity within a wall of the hermetically sealed chamber.

The present disclosure also relates to an apparatus that includes an actuation module, a detection module, a comparison module, and a recognition module. The actuation module commands an acoustic wave actuator to propagate an acoustic wave through a fluid medium. The fluid medium is within a hermetically sealed chamber and is substantially isolated from an external atmosphere. The detection module receives pressure wave data from an acoustic wave transducer that is in fluid contact with the acoustic wave. The comparison module calculates an acoustic velocity of the acoustic wave based on the pressure wave data and compares the acoustic velocity to a predetermined threshold velocity. The recognition module recognizes composition changes to the fluid medium caused by a leak in the hermetically sealed chamber when the acoustic velocity meets the predetermined threshold.

According to one embodiment, the pressure wave data includes resonance frequency data of the fluid medium. In another embodiment, the pressure wave data includes wavelength and frequency data of the fluid medium. The composition change recognized by the recognition module may include changes in a relative concentration of constituents of the fluid medium.

Still further, the present disclosure relates to a method for detecting a leak in a hermetically sealed chamber. The method includes propagating an acoustic wave through a fluid medium. The fluid medium is within a hermetically sealed chamber and is substantially isolated from an external atmosphere. The method further includes detecting fluid pressure wave data related to the acoustic wave in the fluid medium and calculating an acoustic velocity based on the fluid pressure wave data. Once the acoustic velocity has been calculated, the method includes comparing the acoustic velocity to a predetermined threshold velocity and recognizing composition changes to the fluid medium caused by a leak in the hermetically sealed chamber when the acoustic velocity meets the predetermined threshold. In one embodiment, detecting the fluid pressure wave data in the fluid medium comprises detecting a resonant frequency of the acoustic wave or detecting one or more of a wavelength and a frequency of the acoustic wave.

The described features, structures, advantages, and/or characteristics of the subject matter of the present disclosure may be combined in any suitable manner in one or more embodiments and/or implementations. In the following description, numerous specific details are provided to impart a thorough understanding of embodiments of the subject matter of the present disclosure. One skilled in the relevant art will recognize that the subject matter of the present disclosure may be practiced without one or more of the specific features, details, components, materials, and/or methods of a particular embodiment or implementation. In other instances, additional features and advantages may be recognized in certain embodiments and/or implementations that may not be present in all embodiments or implementations. Further, in some instances, well-known structures, materials, or operations are not shown or described in detail to avoid obscuring aspects of the subject matter of the present disclosure. The features and advantages of the subject matter of the present disclosure will become more fully apparent from the following description and appended claims, or may be learned by the practice of the subject matter as set forth hereinafter.

### BRIEF DESCRIPTION OF THE DRAWINGS

In order that the advantages of the subject matter may be more readily understood, a more particular description of the subject matter briefly described above will be rendered by reference to specific embodiments that are illustrated in the appended drawings. Understanding that these drawings depict only typical embodiments of the subject matter and are not therefore to be considered to be limiting of its scope, the subject matter will be described and explained with additional specificity and detail through the use of the drawings, in which:

FIG. 1 is a schematic diagram of one embodiment of a leak detection apparatus that includes an acoustic wave actuator and an acoustic wave transducer within a hermetically sealed chamber;

FIG. 2A is a perspective view of one embodiment of a hard disk drive system that includes hard disk drive components, an acoustic wave actuator, and an acoustic wave transducer within a hermetically sealed hard disk drive chamber, with a top panel of the hard disk drive chamber not shown;

FIG. 2B is a perspective view of another embodiment of a hard disk drive system that includes hard disk drive components and an acoustic wave transducer within a hermetically sealed hard disk drive chamber, with a top panel of the hard disk drive chamber not shown;

FIG. 3A is a schematic diagram of a hard disk drive system that shows one embodiment of an acoustic wave transducer;

FIG. 3B is a schematic diagram of a hard disk drive system that shows another embodiment of an acoustic wave transducer;

FIG. 3C is a schematic diagram of a hard disk drive system that shows another embodiment of an acoustic wave transducer;

FIG. 3D is a schematic diagram of a hard disk drive system that shows yet another embodiment of an acoustic wave transducer;

FIG. 4 is a schematic block diagram of one embodiment of a controller apparatus for detecting leaks in a hermetically sealed chamber; and

FIG. 5 is a schematic flowchart diagram of one embodiment of a method for detecting leaks in a hermetically sealed chamber.

### DETAILED DESCRIPTION

Reference throughout this specification to “one embodiment,” “an embodiment,” or similar language means that a particular feature, structure, or characteristic described in connection with the embodiment is included in at least one embodiment of the present disclosure. Appearances of the phrases “in one embodiment,” “in an embodiment,” and similar language throughout this specification may, but do not necessarily, all refer to the same embodiment. Similarly, the use of the term “implementation” means an implementation having a particular feature, structure, or characteristic described in connection with one or more embodiments of the present disclosure, however, absent an express correlation to indicate otherwise, an implementation may be associated with one or more embodiments.

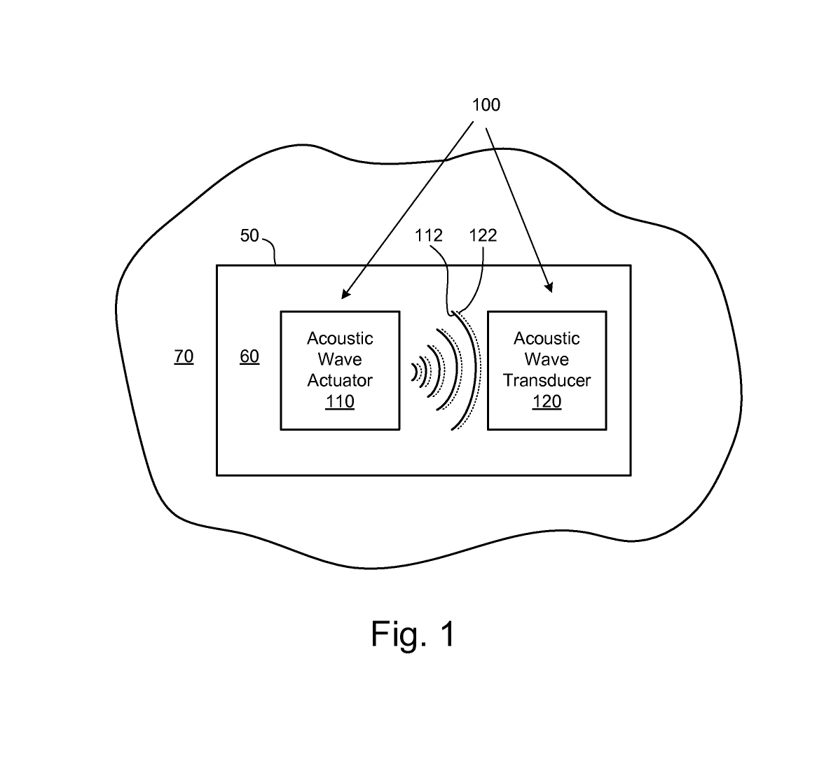

FIG. 1 is a schematic block diagram of one embodiment of a leak detection apparatus 100 that includes an acoustic wave actuator 110 and an acoustic wave transducer 120 within a hermetically sealed chamber 50. Generally, the acoustic wave actuator 110 initiates the propagation of an acoustic wave 112 through a fluid medium 60 within a hermetically sealed chamber 50. The acoustic wave 112 imparts a fluid pressure wave 122 in the fluid medium 60 that is detected by the acoustic wave transducer 120 or receiver. The terms acoustic wave 112 and fluid pressure wave 122 both refer to the longitudinal sound wave that propagates through a medium. More specifically, the term acoustic wave 112 is used in reference to the actuation of the sound wave, while the term fluid pressure wave 122 is used in reference to measuring the effect of the sound wave as it moves through the fluid medium 60. Thus, while both the acoustic wave 112 and the fluid pressure wave 122 are, at times, described and depicted separately throughout the disclosure, both terms refer to a sound wave traveling through a fluid medium 60. In other words, since a sound wave is merely a patterned compression and decompression of the particles of the medium through which the sound propagates, the term acoustic wave 112 generally is associated with controllably actuating the sound wave and the term fluid pressure wave 122 generally is associated with sensing and detecting the sound wave.

Fluctuations and variations in the resultant fluid pressure wave 122 correspond to changes in the composition of the fluid medium 60 within the hermetically sealed chamber 50. Such composition changes of the fluid medium 60 are often the result of a leak in the hermetically sealed chamber 50, which allows external atmosphere 70 to mix with the fluid medium 60 and/or allows the fluid medium 60 to dissipate out of the chamber 50 and into the external atmosphere. Thus, the term composition change, and similar terms used throughout the present disclosure, refers to a change in the concentration of the atoms/molecules that constitute the fluid medium 60 and/or a change in pressure of the fluid medium 60.

Many applications, such as hard disk drives, are often hermetically sealed to isolate a contained fluid medium 60 from an external atmosphere 70. For example, hard disk drives, semiconductor devices, solid-state memory devices, computer/electrical compartments, food containers, pharmaceutical packages, chemical containment vessels, etc., all may be implemented with a hermetically sealed internal atmosphere. Accordingly, although many specific details are included throughout the present disclosure in relation to the specific embodiment of a hard disk drive chamber 51 as the hermetically sealed chamber 50, one of ordinary skill in the art will recognize that the teachings of the present disclosure can be applied to other implementations/applications of hermetically sealed chambers 50.

On a related note, the fluid medium 60 that constitutes the internal atmosphere within the hermetically sealed chamber 50 may be a liquid and/or a gas and may be particularly composed of certain atoms/molecules that are selected according to the specifics of a given application. For example, an inert gas, such as helium, may be the fluid medium 60 sealed inside the chamber 50. In one embodiment, the fluid medium 60 may be configured to have a certain pressure in order to promote the proper storage and/or operation of any components and materials within the chamber 50.

The hermetically sealed chamber 50 houses and contains internal components. In certain implementations, the chamber 50 includes two or more sections coupled together to maintain the sealing nature of the chamber. In one embodiment, the hermetically sealed chamber 50 maintains the internal atmosphere at a pressure below atmospheric pressure. The hermetically sealed chamber 50 can be made from any of various materials, such as plastics, polymers, metals, composites and the like. The chamber 50 may further include fasteners or attachment features (not depicted) that allow the hermetically sealed chamber 50 to be mounted to other structures. Additionally, in some embodiments, the hermetically sealed chamber 50 may include feed-through connectors that controllably allow energy and/or matter to pass through the walls of the sealed chamber 50.

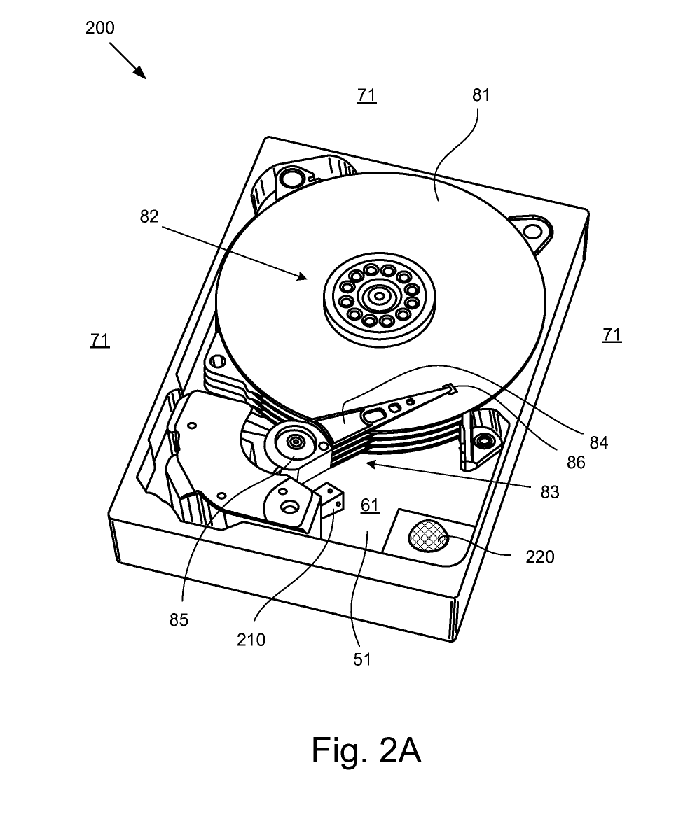

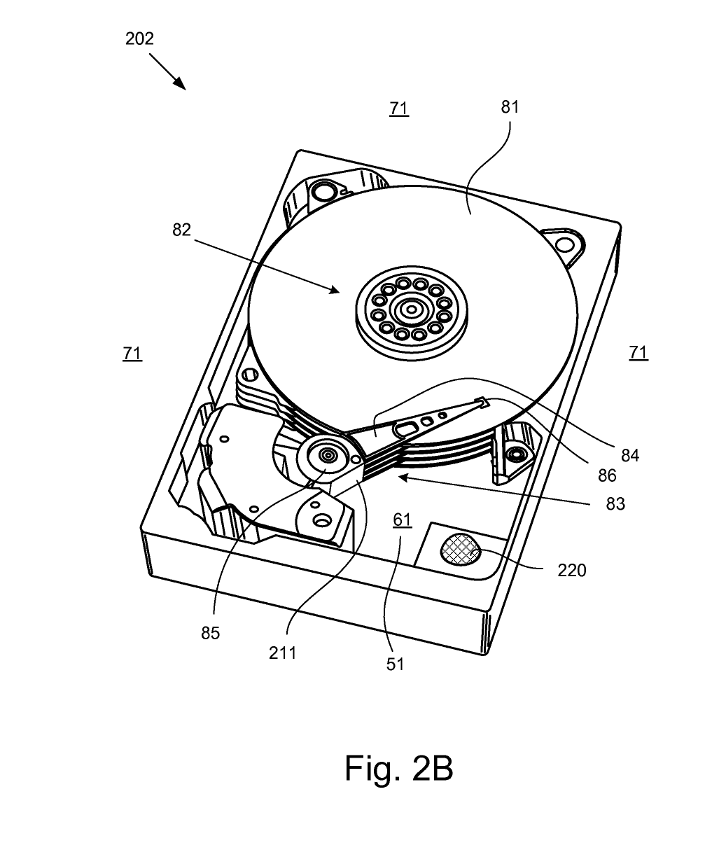

FIG. 2A is a perspective view of a hard disk drive system 200 that includes hard disk drive components (elements with reference numbers in the 80′s), one embodiment of an acoustic wave actuator 210, and one embodiment of an acoustic wave transducer 220 within a hermetically sealed hard disk drive chamber 51, with a top panel of the hard disk drive chamber 51 not shown in order to show the components contained therein. As described above, in one embodiment, the hermetically sealed chamber 50 is a hard disk drive chamber 51 that houses and protects hard disk drive components 81, 82, 83. The hard disk drive chamber 51 can be hermetically sealed to isolate a hard disk drive atmosphere 61 from an external atmosphere 71 in order to maintain a proper atmosphere for the rotating magnetic disks. For example, the hard disk drive atmosphere 61 may be a helium gas that allows the heads 86 of the read/write assembly 83 to smoothly “fly” over the magnetic disks 81 at a height that is comparatively less than non-hermetically sealed hard disk drives. The fly height of the heads 86 is important because the closer the heads 86 are to the magnetic bits of the disk 81, the signal-to-noise ratio is increased, thus enabling the hard disk drive to have an increased bit density (i.e., higher data storage capacity).

The hard disk drive system 200 includes a disk (i.e., a disk platter) 81 of magnetic recording media. In other embodiments, the hard disk drive system 200 may be configured similar to a so-called hybrid hard disk drive that includes a combination of flash media and magnetic disk media. In yet other embodiments, the hard disk drive system 200 can be another type of magnetic storage device or even another type of data storage device, such as an optical recording device. Generally, the hard disk drive system 200 includes one or more disks 81, a spindle 82 driven by a spindle motor, and a read/write head assembly 83. The read/write head assembly 83 includes one or more armatures 84 coupled to a base 85 with transducer heads 86. Although the hard disk drive system 200 depicted in FIG. 2 is shown having four armatures 84 and four disks 81, any number of disks 81 and read/write head armatures 84 may be employed.

The armatures 84 of the read/write head assembly 83 extend parallel to each other away from the base 85 to cantilevered end portions where the transducer heads 86 are disposed. Each armature 84 is a relatively thin plate-like element, which has a width that, in certain implementations, decreases in a direction extending away from the base 85. The armatures 84 are spaced apart vertically (e.g., top-to-bottom direction) such that a disk 81 can be positioned between adjacent armatures 84. In some instances, the armatures 84 are spaced an equal distance apart from each other. Each armature 84 defines a top surface and a bottom surface that opposes the top surface. In certain implementations, the top and bottom surfaces oppose each other when they define generally opposite sides of the corresponding armature 84. According to certain implementations, the top and bottom surfaces oppose each other when the top and bottom surfaces are parallel to each other, and spaced apart from each other by a thickness of the corresponding armature 84. The opposing surfaces can, but need not, be flat. The armatures 84 may include apertures for attachment of other components or for weight saving purposes. In some embodiments, the armatures 84 are integrally formed with the base 85 such that they form a monolithic one-piece construction with the base 85. In other embodiments, the armatures 84 are formed separate from the base 85 and are coupled to the base in a separate processing step via any of various coupling techniques.

The spindle 82 is operably connected to the hard disk drive chamber 51 via the spindle motor. The spindle 121 is co-rotatably coupled to the spindle motor such that the spindle 82 motor rotatably drives the spindle. Accordingly, the spindle 82 can be considered to be part of or integral with the spindle motor. The disks 81 are operably connected to the spindle 82 via respective hubs fixedly secured to respective disks 81 and co-rotatably coupled to the spindle 82. In this manner, the spindle 82 defines a central axis of each disk 81. As the spindle 82 rotates, the disks 81 correspondingly rotate. Accordingly, the spindle motor can be operatively controlled to rotate the disks 81 a controlled amount and at a controlled rate. The disks 81 can include magnetic recording media organized into a plurality of tracks that store data.

As the disks 81 rotate, the read/write head assembly 83 positions the armatures 84, specifically the heads 86 connected to each armature 84, such that the heads 86 are positioned over a specified radial area of the disks for read or write operations. In an idle mode, the read/write head assembly 83 is controlled to position the armatures 84 radially outwardly such that each head 86 is parked or unloaded onto a landing support secured to the chamber 51. The hard disk drive system may further include an electrical hardware board mounted to chamber 51. In this manner, the electrical hardware board is on-board or contained within the hard disk drive system, as opposed to forming part of an electrical device external to or separate from the hard disk drive system 200. Generally, the electrical hardware board includes hardware and/or circuitry used to control operation of the various components of the hard disk drive system 200. The electrical hardware board may include a printed circuit board on or in which the hardware and/or circuitry is mounted.

Within the hard disk drive chamber 51 is one embodiment of an acoustic wave actuator 210 and one embodiment of an acoustic wave transducer 220. As described above, the acoustic wave actuator 210 is operably configured to control propagation of an acoustic wave (i.e., a sound wave) through the hard disk drive atmosphere 61. The acoustic wave actuator 210, analogous to the acoustic wave actuator generally described above with reference to FIG. 1, may be a component that is functionally independent from the other internal components of the hard disk drive system 200. For example, the acoustic wave actuator 210 may be a device that actuates a physical impact between two elements, thus generating an acoustic sound wave that propagates through the internal hard disk drive atmosphere 61. In another embodiment, the actuator 210 may be a vibrating or pulsating device (e.g., piezoelectric material). In other words, the acoustic wave actuator 210 may be any implement that controllably generates an acoustic sound wave. In one embodiment, the actuator 210 is precisely controllable so as to be able to produce a substantially identical acoustic sound wave upon each actuation. In another embodiment, as described below with reference to FIG. 2B, the acoustic wave actuator 210 may actually be an existing component of a conventional hard disk drive system 200.

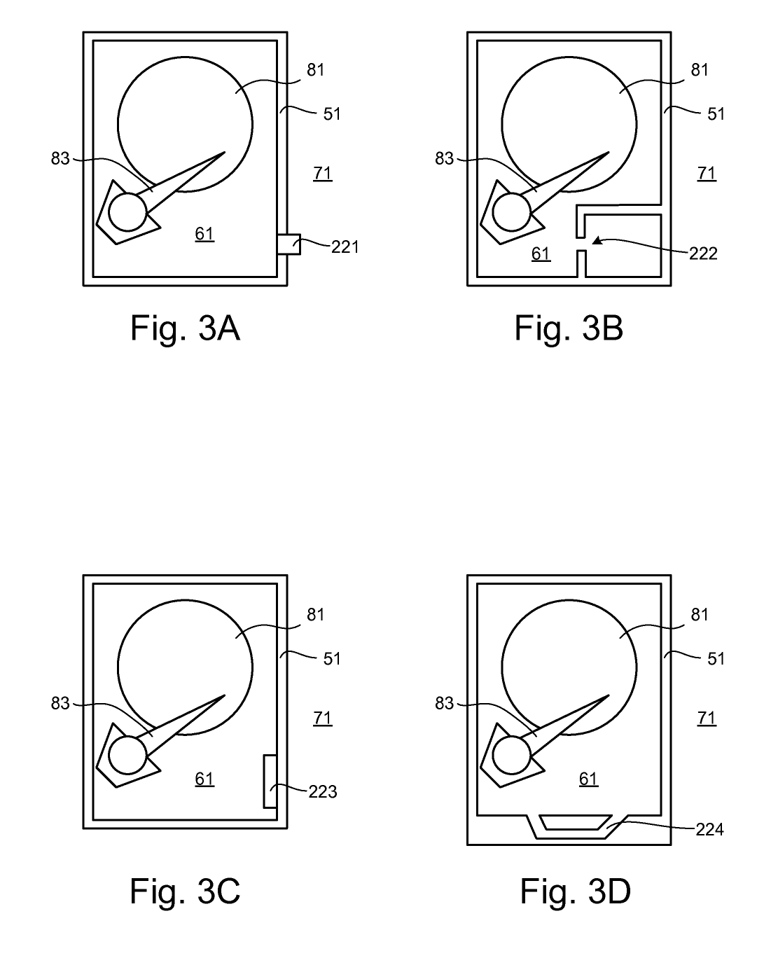

The acoustic wave transducer 220 detects the acoustic wave propagation though the internal atmosphere 61 of the hard disk drive chamber 51 by sensing the fluid pressure wave. In one embodiment, the acoustic wave transducer 220 is a microphone configured and calibrated to detect the frequency and magnitude of the sound waves actuated by the actuator 210. Further details relating to the acoustic wave transducer 220 are included below with reference to FIGS. 3A-3D.

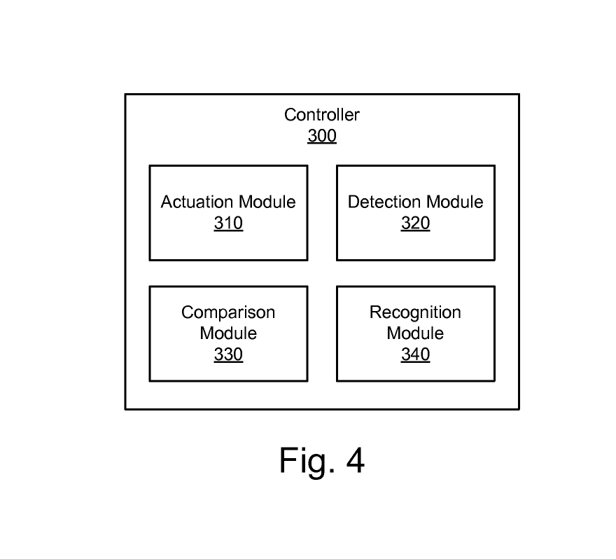

Once the acoustic wave transducer 220 has detected the fluid pressure wave data, a comparison module (not depicted in FIG. 2A) calculates an acoustic velocity of the acoustic wave based on the fluid pressure wave data. The acoustic velocity is then compared to a predetermined threshold velocity in order to determine if there is a leak in the hermetically sealed chamber. In other words, the detected/calculated acoustic velocity will change if the internal atmosphere, through which the wave is propagating, has experienced a composition change due to a leak in the hermetically sealed hard disk drive chamber. Additional details regarding the comparison module are included below with reference to FIG. 4.

FIG. 2B is a perspective view of another embodiment of a hard disk drive system 200 that includes hard disk drive components and an acoustic wave transducer 220 within a hermetically sealed hard disk drive chamber 51, with a top panel of the hard disk drive chamber 51 not shown. The hard disk drive system 200 and the internal components 81, 82, 83, 84, 85, 86 are substantially described above. However, FIG. 2B does not include a separate and standalone component to function as the acoustic wave actuator 210. Instead, FIG. 2B identifies a surface 211 of the read/write head assembly 83 that functions as the acoustic wave actuator 210.

In such an embodiment, upon performing a controlled action with the read/write head assembly 83, a known sound may be generated and propagated through the internal atmosphere 61 of the hard disk drive chamber 81. For example, the operation of moving the armatures 84 of the read/write head assembly 83 radially outward, with respect to the disks 81, to a landing/idle position may create a consistent sound which can be detected by the acoustic wave transducer 220. In another embodiment, the spindle 82 and/or armatures 84 of the read/write head assembly 83 may include features that operably generate a sound to be detected by the acoustic wave transducer 220. Thus, the propagation of an acoustic sound wave may be actuated by an existing component of a conventional hard disk drive performing a standard operation (i.e., spinning of the disk platter 82, movement of the read/write head assembly 83, etc.). Still further, in another embodiment the acoustic wave may be actuated by dropping or impacting the hard disk drive chamber 51 (i.e., during product testing/maintenance) under known control conditions. In another embodiment, the acoustic wave actuator 210 may be implemented as any of various devices, assemblies, operations, etc.

FIG. 3A is a schematic diagram of a hard disk drive system that shows one embodiment of an acoustic wave transducer 221. The acoustic wave transducer 221 depicted in FIG. 3A is a microphone or similar sound detection device that is mounted external to the hard disk drive chamber 51. The transducer 221 may be in direct physical contact with the hard disk drive chamber 51 to indirectly sense the sound wave propagating through the internal fluid medium 61. In another embodiment, the hard disk drive chamber 51 may include an aperture with a thin-film element disposed over the aperture. The propagating acoustic sound wave may cause the thin-film to oscillate/vibrate accordingly, and the transducer 221 may detect the physical oscillations/vibrations of the thin-film.

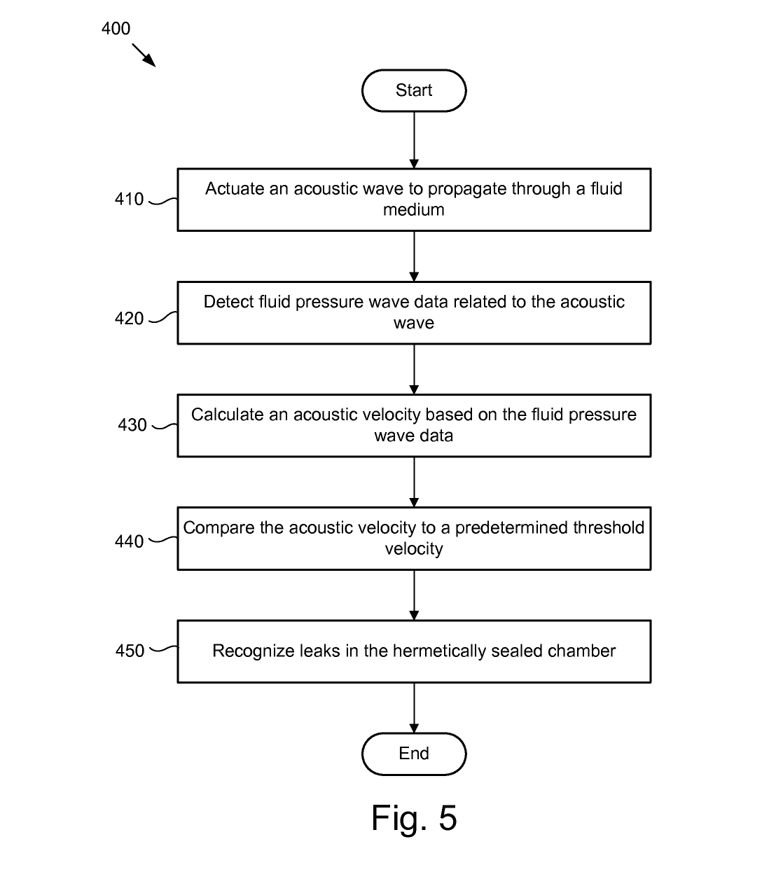

FIG. 3B is a schematic diagram of a hard disk drive system that shows another embodiment of an acoustic wave transducer 222. The acoustic wave transducer 222 depicted in FIG. 3B is a Helmholtz type resonator. A Helmholtz type resonator detects the acoustic resonance of a wave within a cavity. An acoustic sound wave propagates through a medium via alternating compression and decompression actions. This alternating compression and decompression causes fluid to alternately flow in and out of a cavity through the “neck” of the cavity. FIG. 3C is a schematic diagram of a hard disk drive system that shows another embodiment of an acoustic wave transducer 223 that is similar to the Helmholtz type resonator. The transducer 223 in FIG. 3C is a resonance tube that can be mounted within the hard disk drive chamber 51 to detect and measure the resonance of acoustic sound waves within the chamber 51. FIG. 3D is a schematic diagram of a hard disk drive system that shows yet another embodiment of a channel 224 in the wall of the chamber 51 that functions as a resonator. These resonance transducers 222, 223, 224 all operate on the same general principle, as described in greater detail below with reference to FIGS. 4 and 5. Generally, these resonance transducers 222, 223, 224 determine the resonance frequency, which can be used to calculate the acoustic velocity of the sound wave. Variations in the acoustic velocity of the sound wave are often associated with composition changes to the internal atmosphere 61 of the chamber 51.

FIG. 4 is a schematic block diagram of one embodiment of a controller apparatus 300 for detecting leaks in a hermetically sealed chamber. The controller apparatus 300 includes an actuation module 310, a detection module 320, a comparison module 330, and a recognition module 340. The actuation module 310 is configured to instruct an acoustic wave actuator to propagate an acoustic wave through a fluid medium that is isolated within a hermetically sealed chamber. The actuation module 310, according to one embodiment, precisely controls the actuation of the acoustic wave in order to generate a substantially standard/uniform sound wave each time.

The detection module 320 receives pressure wave data from an acoustic wave transducer that is in fluid contact with the acoustic wave. The pressure wave data may include frequency, magnitude, wavelength, and/or resonance information relating to the acoustic sound wave. The pressure wave data may be detected using a microphone-type device or a resonance-type sensor, among others.

The comparison module 330 calculates the acoustic velocity of the acoustic wave based on the pressure wave data and compares the acoustic velocity to a predetermined threshold velocity. Those of ordinary level of skill will recognize methods for calculating the acoustic velocity based on the type of pressure wave data received and based on the relative configuration of the acoustic wave actuator 210 and the acoustic wave transducer 220. For example, pressure wave data regarding the resonance frequency of the acoustic wave can be used to calculate the wavelength of the fluid pressure waves, which in turn can be used to determine the acoustic velocity. Depending on the specification application, the comparison module 330 may assume the ideal gas law applies and may utilize simplified equations for calculating the acoustic velocity.

In other words, the detected/calculated acoustic velocity will change if the internal atmosphere, through which the wave is propagating, has experienced a composition change due to a leak in the hermetically sealed hard disk drive chamber. The predetermined threshold velocity is a baseline or an expected acoustic velocity range based on the original, uncontaminated internal atmosphere of the hermetically sealed chamber. If the measured acoustic velocity meets the threshold velocity (i.e., is sufficiently different from an expected acoustic velocity), it may be inferred that a leak has developed in the hermetically sealed chamber, which caused a composition change in the internal atmosphere and in turn affected the acoustic velocity of the sound wave.

The recognition module 340 recognizes composition changes to the fluid medium based on changes to the acoustic velocity. Since acoustic velocity is based on the properties of the medium through which it is propagating, composition changes to the fluid medium result in different acoustic velocities. For example, if a helium-enriched, negative pressure atmosphere is maintained within a hermetically sealed chamber, the acoustic velocity of an acoustic wave propagating through the internal atmosphere is known. However, if there was a leak in the hermetically sealed chamber, external atmosphere (e.g., air) would mix with the helium-enriched internal atmosphere, which would cause the acoustic velocity of an acoustic sound wave to deviate from the known value.

FIG. 5 is a schematic flowchart diagram of one embodiment of a method 400 for detecting leaks in a hermetically sealed chamber 50. The method 400 includes actuating the acoustic wave to propagate through a fluid medium at 410 and detecting fluid pressure waves in the fluid medium caused by the acoustic wave at 420. As described above, actuating the acoustic wave may be accomplished using an existing component of a hard disk drive or actuating the acoustic wave may be accomplished using an independent component that is specifically configured to create a sound within the hard disk drive chamber. The method 400 may include performing several initial actuation and detection steps in order to acquire data that will be used to establish a baseline against which to compare future data in order to determine the presence of a leak.

The method 400 further includes calculating the acoustic velocity of the fluid pressure waves in the fluid medium at 430, comparing the acoustic velocity to a predetermined threshold velocity at 440, and recognizing composition changes to the fluid medium based caused by a leak in the hermetically sealed chamber 450. As described above, the several rounds of actuating 410, detecting 420, and calculating 430 may be initially performed to establish a baseline acoustic velocity (i.e., an expected acoustic velocity) and to determine an acceptable threshold velocity. In such embodiments, subsequent actuations, detections, and calculations may result in a measured acoustic velocity that differs from the baseline acoustic velocity and meets the predetermined threshold velocity, thus signifying a change in the composition of the fluid medium within the hermetically sealed chamber caused by a leak.

As stated previously, although the majority of the embodiments described above are in relation to a hard disk drive, in other embodiments the principles and features of the present disclosure can be applied to other hermetically sealed chamber devices that could benefit from a leak detection apparatus, system, and method.

As will be appreciated by one skilled in the art, aspects of the present disclosure may be embodied as a system, method, and/or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the present disclosure may take the form of a computer program product embodied in one or more computer readable medium(s) having program code embodied thereon.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of program code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of program code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the program code may be stored and/or propagated on in one or more computer readable medium(s).

The computer readable medium may be a tangible computer readable storage medium storing the program code. The computer readable storage medium may be, for example, but not limited to, an electronic, magnetic, optical, electromagnetic, infrared, holographic, micromechanical, or semiconductor system, apparatus, or device, or any suitable combination of the foregoing.

More specific examples of the computer readable storage medium may include but are not limited to a portable computer diskette, a hard disk, a random access memory (RAM), a read-only memory (ROM), an erasable programmable read-only memory (EPROM or Flash memory), a portable compact disc read-only memory (CD-ROM), a digital versatile disc (DVD), an optical storage device, a magnetic storage device, a holographic storage medium, a micromechanical storage device, or any suitable combination of the foregoing. In the context of this document, a computer readable storage medium may be any tangible medium that can contain, and/or store program code for use by and/or in connection with an instruction execution system, apparatus, or device.

The computer readable medium may also be a computer readable signal medium. A computer readable signal medium may include a propagated data signal with program code embodied therein, for example, in baseband or as part of a carrier wave. Such a propagated signal may take any of a variety of forms, including, but not limited to, electrical, electro-magnetic, magnetic, optical, or any suitable combination thereof. A computer readable signal medium may be any computer readable medium that is not a computer readable storage medium and that can communicate, propagate, or transport program code for use by or in connection with an instruction execution system, apparatus, or device. Program code embodied on a computer readable signal medium may be transmitted using any appropriate medium, including but not limited to wire-line, optical fiber, Radio Frequency (RF), or the like, or any suitable combination of the foregoing.

In one embodiment, the computer readable medium may comprise a combination of one or more computer readable storage mediums and one or more computer readable signal mediums. For example, program code may be both propagated as an electro-magnetic signal through a fiber optic cable for execution by a processor and stored on RAM storage device for execution by the processor.

Program code for carrying out operations for aspects of the present disclosure may be written in any combination of one or more programming languages, including an object oriented programming language such as Java, Smalltalk, C++, PHP or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The computer program product may be shared, simultaneously serving multiple customers in a flexible, automated fashion. The computer program product may be standardized, requiring little customization and scalable, providing capacity on demand in a pay-as-you-go model.

The computer program product may be stored on a shared file system accessible from one or more servers. The computer program product may be executed via transactions that contain data and server processing requests that use Central Processor Unit (CPU) units on the accessed server. CPU units may be units of time such as minutes, seconds, hours on the central processor of the server. Additionally the accessed server may make requests of other servers that require CPU units. CPU units are an example that represents but one measurement of use. Other measurements of use include but are not limited to network bandwidth, memory usage, storage usage, packet transfers, complete transactions etc.

Aspects of the embodiments may be described above with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by program code. The program code may be provided to a processor of a general purpose computer, special purpose computer, sequencer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The program code may also be stored in a computer readable medium that can direct a computer, other programmable data processing apparatus, or other devices to function in a particular manner, such that the instructions stored in the computer readable medium produce an article of manufacture including instructions which implement the function/act specified in the schematic flowchart diagrams and/or schematic block diagrams block or blocks.

The program code may also be loaded onto a computer, other programmable data processing apparatus, or other devices to cause a series of operational steps to be performed on the computer, other programmable apparatus or other devices to produce a computer implemented process such that the program code which executed on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and computer program products according to various embodiments of the present disclosure. In this regard, each block in the schematic flowchart diagrams and/or schematic block diagrams may represent a module, segment, or portion of code, which comprises one or more executable instructions of the program code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and program code.

The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

As used herein, the phrase “at least one of”, when used with a list of items, means different combinations of one or more of the listed items may be used and only one of the items in the list may be needed. The item may be a particular object, thing, or category. In other words, “at least one of” means any combination of items or number of items may be used from the list, but not all of the items in the list may be required. For example, “at least one of item A, item B, and item C” may mean item A; item A and item B; item B; item A, item B, and item C; or item B and item C. In some cases, “at least one of item A, item B, and item C” may mean, for example, without limitation, two of item A, one of item B, and ten of item C; four of item B and seven of item C; or some other suitable combination.

The present subject matter may be embodied in other specific forms without departing from its spirit or essential characteristics. The described embodiments are to be considered in all respects only as illustrative and not restrictive. All changes which come within the meaning and range of equivalency of the claims are to be embraced within their scope.

What is claimed is:

1. A leak detection apparatus, comprising:
an acoustic wave actuator mounted within a hermetically sealed chamber, wherein the hermetically sealed chamber isolates a fluid medium from an external atmosphere, wherein the acoustic wave actuator propagates an acoustic wave through the fluid medium;
an acoustic wave transducer mounted within the hermetically sealed chamber, wherein the acoustic wave transducer detects fluid pressure wave data related to the acoustic wave; and
a comparison module that calculates an acoustic velocity based on the fluid pressure wave data and compares the acoustic velocity to a predetermined threshold velocity.

2. The apparatus of claim 1, further comprising a recognition module that recognizes composition changes to the fluid medium caused by a leak in the hermetically sealed chamber when the acoustic velocity meets the predetermined threshold.

3. The apparatus of claim 1, wherein the acoustic wave transducer comprises a microphone.

4. The apparatus of claim 1, wherein the acoustic wave transducer comprises a resonant frequency detector.

5. The apparatus of claim 4, wherein the acoustic wave transducer is selected from the group comprising a Helmholtz type cavity, a resonance tube, and a resonance cavity within a wall of the hermetically sealed chamber.

6. A system, comprising:
a hard disk drive chamber, wherein the hard disk drive chamber is hermetically sealed to isolate a hard disk drive atmosphere from an external atmosphere;
at least one disk platter assembly mounted within the hard disk drive chamber;
a read/write head assembly mounted within the hard disk drive chamber;
an acoustic wave actuator mounted within the hard disk drive chamber, wherein the acoustic wave actuator propagates an acoustic wave through the hard disk drive atmosphere; and
an acoustic wave transducer mounted within the hard disk drive chamber, wherein the acoustic wave transducer detects fluid pressure wave data related to the acoustic wave.

7. The system of claim 6, further comprising a comparison module that calculates an acoustic velocity based on the fluid pressure wave data and compares the acoustic velocity to a predetermined threshold velocity.

8. The system of claim 7, further comprising a recognition module that recognizes composition changes to the hard disk drive atmosphere caused by a leak in the hard disk drive chamber when the acoustic velocity meets the predetermined threshold.

9. The system of claim 6, wherein the acoustic wave actuator is a standalone component that is independent from conventional hard disk drive components.

10. The system of claim 6, wherein the acoustic wave actuator is an existing hard disk drive component capable of creating the acoustic wave that propagates through the hard disk drive atmosphere.

11. The system of claim 6, wherein the acoustic wave transducer comprises a microphone.

12. The system of claim 6, wherein the acoustic wave transducer comprises a resonant frequency detector.

13. The system of claim 12, wherein the acoustic wave transducer is selected from the group comprising a Helmholtz type cavity, a resonance tube, and a resonance cavity within a wall of the hermetically sealed chamber.

14. An apparatus, comprising:
an actuation module that commands an acoustic wave actuator to propagate an acoustic wave through a fluid medium, wherein the fluid medium is within a hermetically sealed chamber and is substantially isolated from an external atmosphere;
a detection module that receives pressure wave data from an acoustic wave transducer that is in fluid contact with the acoustic wave;
a comparison module that calculates an acoustic velocity of the acoustic wave based on the pressure wave data and compares the acoustic velocity to a predetermined threshold velocity; and
a recognition module that recognizes composition changes to the fluid medium caused by a leak in the hermetically sealed chamber when the acoustic velocity meets the predetermined threshold.

15. The apparatus of claim 14, wherein the pressure wave data comprises resonance frequency data of the fluid medium.

16. The apparatus of claim 14, wherein the pressure wave data comprises wavelength and frequency data of the fluid medium.

17. The apparatus of claim 14, wherein composition changes comprise changes in a relative concentration of constituents of the fluid medium.

18. A method, comprising:
propagating an acoustic wave through a fluid medium, wherein the fluid medium is within a hermetically sealed chamber and is substantially isolated from an external atmosphere;
detecting fluid pressure wave data related to the acoustic wave in the fluid medium;
calculating an acoustic velocity based on the fluid pressure wave data;
comparing the acoustic velocity to a predetermined threshold velocity; and
recognizing composition changes to the fluid medium caused by a leak in the hermetically sealed chamber when the acoustic velocity meets the predetermined threshold.

19. The method of claim 18, wherein detecting fluid pressure wave data in the fluid medium comprises detecting a resonant frequency of the acoustic wave.

20. The method of claim 18, wherein detecting fluid pressure wave data in the fluid medium comprises detecting one or more of a wavelength and a frequency of the acoustic wave.
